(19) United States
(12) Patent Application Publication
(10) Pub. No.: US 2024/0389578 A1
(43) Pub. Date: Nov. 28, 2024

(54) SUSPENDING SYSTEMS CONSTRUCTED FROM HYDROTROPES

(71) Applicant: Stepan Company, Northbrook, IL (US)

(72) Inventors: John Hawkins, Greater Manchester (GB); George Forrest, Greater Manchester (GB); Andrew Marsden, Yorkshire (GB)

(21) Appl. No.: 18/798,219

(22) Filed: Aug. 8, 2024

Related U.S. Application Data
(63) Continuation of application No. PCT/US2023/062211, filed on Feb. 8, 2023.
(60) Provisional application No. 63/308,452, filed on Feb. 9, 2022.

(51) Int. Cl. A01N 25/04; A01N 25/30

(52) U.S. Cl. CPC A01N 25/04; A01N 25/30

(57) ABSTRACT

Non-settling aqueous-based pourable suspensions may be prepared from mixtures of water soluble and oil soluble amphiphiles with from 6 to 11 carbon atoms in the hydrophobic portion of the amphiphile. The water soluble amphiphiles are classed as hydrotropes. The systems are low foaming and are particularly useful for suspending problematic materials such as graphene and diamond powder.

### RELATED APPLICATIONS

This application claims priority to and is a continuation of co-pending PCT Application No. PCT/US23/62211 having an international filing date of Feb. 8, 2023, which is incorporated herein by reference, and which claims priority to U.S. Provisional Application No. 63/308,452, having a filing date of Feb. 9, 2022, which is also incorporated herein by reference in its entirety.

### FIELD OF THE INVENTION

The present invention relates to a structured, low foaming amphiphile suspending system for suspending water-insoluble or sparingly water-soluble solid particles or liquids. The invention further relates to compositions comprising the suspending system.

### BACKGROUND OF THE INVENTION

Formulating suspensions of water insoluble or sparingly soluble solids or liquids in industrial compositions such as lapping fluids, pigment suspensions or agrochemical dispersions presents a long-standing problem. Formulators need to suspend a wide variety of ingredients such as diamond powder or iron oxide, and agrochemical formulators in particular have pressing requirements to suspend actives such as bifenthrin. More recently, the discoveries of carbon nanotubes and graphene have given formulators considerable problems, such as how to prepare them as stable dispersions in aqueous media.

We have discovered novel structured low foaming compositions that are extremely cost effective and capable of suspending immiscible solid or liquid particles without sedimentation using blends of short chain amphiphiles in water.

The term “structured system” as used herein is intended to mean a pourable composition comprising water, amphiphile, and optionally other dissolved matter, which together form a mesophase, or dispersion of a mesophase, in a continuous medium, and which has the ability to immobilize non-colloidal, water-insoluble particles while the system is at rest, thereby forming a stable pourable suspension. The amphiphiles and water interact to form what are usually termed “liquid crystal phases”, or alternately “mesomorphic phases” or “mesophases”.

The term “pourable” is used herein to refer to shear thinning fluids with viscosities around 2000 cps at room temperature (at a shear rate of 21 reciprocal seconds).

Known structured surfactants generally comprise an L-alpha phase, in which bilayers of surfactant are disposed with the hydrophobic portion of the surfactant on the inside and the hydrophilic portion on the outside of the bilayer. The bilayers lie in a parallel or concentric arrangement, usually alternating with layers of an aqueous medium.

Other conventional structured suspending systems may comprise spherulitic phases. Spherulitic phases comprise spheroidal bodies, usually referred to in the art as spherulites, with an onion-like structure comprising concentric shells of surfactant. The spherulites usually have a diameter in the range 0.1 to 15 microns and are dispersed in the aqueous phase in the manner of a classical emulsion, but interacting to form a structured system. Spherulitic systems are described in more detail in EP 0 151 884.

Most structured surfactant systems require the presence of a structurant, as well as surfactant and water in order to form systems capable of suspending solids. The term “structurant” is used to describe any non-surfactant that is capable, when dissolved in water, of interacting with the surfactant to form a structured system. It is typically a surfactant de-solubiliser e.g. an electrolyte. The term “electrolyte” refers to ionic compounds that dissociate at least partially in aqueous solution to provide ions.

A major problem with lamellar structured surfactant suspending systems is that they are formed most readily by high foaming mixtures of detergent (surfactant) plus electrolyte. Such high foaming mixtures are not desirable for industrial low-foaming applications. The low foaming amphiphiles, which are classed as hydrotropes, are very soluble in water and actually tend to disrupt rather than assist the formation of lamellar bi-layers. Previous attempts to formulate industrial low foam suspensions have therefore employed detergents, and, as a consequence, these systems have entailed the use of high concentrations of undesirable electrolytes and antifoams to minimize foaming from the detergent surfactants.

Both electrolyte and antifoam are non-essential components in that they are added at additional cost in order to induce lamellar structure and suppress foam. There is therefore a need for industrial formulators to be able to formulate low foaming suspensions without resorting to adding non-essential components such as electrolytes and antifoams.

Of further concern is that the lamellar bi-layers formed in mixtures of detergent plus electrolyte tend to be present in large vesicles which contain many (e.g. 100-150) bi-layers. Large vesicles are slow to dissolve on dilution with water. Attempts to employ systems containing large vesicles in, for example, personal care formulations have been largely unsuccessful because ‘flash foam’ is generally poor due to the vesicles taking significant time to dissolve in water. Much smaller vesicles with only a few bi-layers would therefore be preferred.

It has been recently discovered (WO 2013/119908 A1) that transparent electrolyte-free lamellar suspending systems can be formulated by preparing an aqueous blend of (for example) a glyceryl fatty acid ester with a surfactant having a high Hydrophilic-Lipophilic Balance (HLB) value (“high HLB surfactant”). Such systems produce copious amounts of foam when they are agitated with water, and as such they are particularly suited for personal care compositions, but not for low foam industrial applications.

An additional consideration is expense. The suspending systems described in WO 2013/119908 A1 contain a high proportion of expensive components e.g. glyceryl caprylate/caprate. Whilst this may not be so much of an issue in personal care, where the cost of the individual components is a small fraction of the selling price, in industrial applications it is very much of a concern.

The low cost amphiphiles of choice would ordinarily be hydrotropes, but up until this point, they have not been employed in lamellar suspending systems because of their tendency to interact with and disrupt liquid crystals. In fact, one of the major applications for hydrotropes is in concentrated detergent systems where they interrelate to prevent the formation of liquid crystal gel phases, in dispensing nozzles for example.

It is an aim of embodiments of the invention to provide a pourable, low-foaming aqueous suspending system that can suspend water-insoluble particles or liquids. It is also an aim of embodiments of the invention to overcome or mitigate at least one problem of the prior art, whether expressly disclosed herein or not.

### BRIEF SUMMARY OF THE INVENTION

According to a first aspect of the invention, there is provided a structured aqueous system having a yield point and capable of suspending particles of solid, liquid or gas, wherein the structured aqueous system comprises a mixture of at least one water soluble amphiphile and at least one water insoluble amphiphile, wherein the at least one water soluble amphiphile is a hydrotrope. In a further aspect, the hydrotrope has at least one polar head group and a lipophilic portion having less than 12 carbon atoms per polar head group. It has been a most unexpected and surprising discovery to find that low foaming structured lamellar suspending systems comprising a high proportion of hydrotrope can be successfully formulated. The systems may have a high optical clarity and have a significant yield point, which is evidenced by the fact that they are capable of suspending air bubbles.

The hydrotrope may be a high HLB hydrotrope having an HLB value of 10 or more.

The at least one water insoluble amphiphile may be a low HLB amphiphile having an HLB value of less than 10.

The low-foaming structured aqueous system can be used to suspend problematic, water-insoluble materials, such as graphene and diamond powder, for use in industrial applications where high-foaming surfactants are not appropriate. Accordingly a further aspect of the invention is a composition comprising (a) a structured aqueous system comprising water and from 2% to 50% by weight based on the weight of the structured aqueous system of a mixture of at least one water soluble amphiphile and at least one water insoluble amphiphile, wherein the at least one water soluble amphiphile is a hydrotrope comprising at least one polar head group and a lipophilic tail group with from 6 to 11 carbon atoms per polar head group; and (b) at least one of solid, liquid, or gaseous particles suspended in the structured aqueous system. In some embodiments, the solid particles comprise about 0.5% to about 60% by weight of the composition. In some embodiments, the solid particles are graphene particles.

Another aspect of the invention is a method of preparing a stable graphene dispersion, comprising (a) forming a structured aqueous system comprising water and from 2% to 50% by weight based on the weight of the structured aqueous system of a mixture of at least one water soluble amphiphile and at least one water insoluble amphiphile, wherein the at least one water soluble amphiphile is a hydrotrope comprising at least one polar head group and a lipophilic tail group with from 6 to 11 carbon atoms per polar head group; and (b) suspending the graphene particles in the structured aqueous system to form the stable graphene dispersion.

### BRIEF DESCRIPTION OF THE DRAWINGS

FIG. 1 shows the chemical structures of exemplary Low HLB amphiphiles and High HLB hydrotropes that can be used in the present invention.

### DETAILED DESCRIPTION OF THE INVENTION

The present invention relates to a suspending system based on a lamellar mesophase that is constructed from particular amphiphilic molecules. It may have a high degree of optical clarity, is low foaming and may be extremely low in electrolytes. A system having a high degree of optical clarity typically has a percent transmittance of light of greater than about 50 using a 1 centimeter cuvette at a wavelength of 570 nanometers wherein the composition is measured in the absence of dyes and opacifiers at 25° C. “Low foaming” means any foam that is generated during processing to form the suspending system is transient and collapses within a few seconds. A system that is extremely low in electrolytes is one that has less than 2%, preferably less than 1% by weight electrolytes. For example, the structured aqueous system may be free of electrolytes. It has wide-ranging applications as a suspending medium for payloads such as pesticides, pigments, graphene, oils etc. It is also believed to be useful in nuclear decommissioning to clean, scour and suspend radioactive particles, and also to suspend high concentrations of lead (for example), making it useful as a liquid radiation shield. It is thought that it could find applications in the emerging field of oil free lubricants.

Analysis of the suspending system by small angle X-ray indicates that the lamellar structure units are regularly sized micro-vesicles comprising 3-6 concentric shells with a 30-40 Angstrom bi-layer spacing. It is believed that the micro-vesicles are arranged in a regular ordered lattice structure. This particular structure has been identified in WO 2013/119908 A1, but the structured system in WO 2013/119908 is formed from mixtures of high-foaming surfactants.

Although the micro-vesicles are overall electrically neutral, the surface of each micro-vesicle (when it is viewed from an adjacent micro-vesicle) has a net positive charge. The like positive charges repel with the consequence that each micro-vesicle is held in an energetic lattice. This lattice energy imparts a yield point, which allows particles to be suspended indefinitely. A suspending system that has a yield point is one that has an initial resistance to applied shear, which can be measured using a cone and plate rheometer.

The amphiphilic molecules used in preparing the suspending system comprise at least one water insoluble amphiphile, and at least one water-soluble amphiphile that is a hydrotrope. A hydrotrope is a molecule that has a hydrophilic or polar head group and a hydrophobic (lipophilic) portion or tail group, but the hydrophobic portion or tail group is generally too small to cause spontaneous self-association or aggregation in aqueous solutions. Hydrotropes are not usually surface active, and typically do not form micelles or lamellar vesicles. Surprisingly, it has now been found that particular combinations of water-insoluble amphiphiles and hydrotropes can form structured systems that have a yield point and are capable of suspending solid particles, liquid droplets, or gas bubbles.

The amphiphiles for use in preparing the structured system should comprise at least one amphiphile with a hydrophilic-lipophilic balance (HLB) that is low, for example less than 10, and at least one amphiphile with a high HLB, for example 10 or greater. The overall HLB of the mixture should be in a range in which liquid crystals form, which may be around 11 to 13, preferably about 12 HLB units.

The low HLB amphiphile has a polar head group comprising a terminal OH group that may be hydroxyl or carboxyl, and comprises a lipophilic (hydrophobic) tail group. It has been found that low HLB amphiphiles that do not include at least one hydroxyl or carboxyl in the polar head group may not induce a structured aqueous system to form. In some embodiments, the low HLB amphiphile may comprise at least one lipophilic tail comprising at least about 4 carbon atoms, about 5, about 6, about 7, about 8, about 9, about 10, about 11, about 12, about 13 or at least about 14 carbon atoms. The lipophilic tail can be linear or branched.

In some embodiments, the low HLB amphiphile may comprise at least one linear tail having a carbon chain comprising at least about 4, about 5, about 6, about 7, about 8, about 9, or about 10 carbon atoms. In some embodiments, the low HLB amphiphile may include at least one hydroxyl group in addition to the terminal OH group. Without wishing to be bound by theory, it is believed that the hydroxyl groups of the low HLB amphiphile interchange protons with the sulphate/carboxyl anions of the hydrotrope, the entire surface of the vesicle being in a state of flux or resonance. This is believed to be the driving force for vesicle formation and the ‘cement’ that holds the vesicles together. Examples of suitable water insoluble amphiphiles for forming the suspending system include 1,2-octanediol, ethyl hexyl glycerine, octanol, octanoic acid, and glyceryl caprate/caprylate.

The high HLB amphiphile (hydrotrope) comprises at least one polar head group and at least one lipophilic tail. The lipophilic tail can be aliphatic or aromatic. The hydrotrope may have a lipophilic tail comprising at least 5, alternatively about 6, about 7, about 8, about 9, about 10 carbon atoms, or about 11 carbons. In some embodiments, the lipophilic tail is a linear lipophilic tail. In embodiments comprising a linear lipophilic tail, the carbon chain may comprise 5, alternatively about 6, about 7, about 8, about 9, about 10 or about 11 carbon atoms. In some embodiments, the lipophilic tail is a cyclic or branched tail. For 6 carbon cyclic (including aromatic) tails, the tail should have at least one pendant methyl group. Alkyl benzene sulphonates containing 6 or more carbon atoms in the alkyl portion are not considered hydrotropes as defined herein. The polar group can comprise a sulfate, sulphonate, carboxylate, or phosphate group. The counterion for the polar head group can be, for example, sodium, potassium, lithium, monoethanolamine, diethanolamine, or triethanolamine.

In some embodiments, the high HLB amphiphile may have dual or twin polar head groups. For example, it is believed that sulphonated oleic acid may function as a high HLB component in the structured aqueous system. Without being bound by theory, this may be due to those molecules in the mixture that have been sulphonated at the double bond to produce a short-tailed, twin-headed hydrotrope. These molecules are believed to bunch and fold in the vesicle so that around 10 carbon atoms are incorporated in the lipophilic portion of the bi-layer. Phosphoric acid di-(C4-C18)-alkyl esters may also function as a hydrotrope in the structured aqueous systems.

In some embodiments, the hydrotrope may be a salt of a C6-C10 carboxylic acid, such as, for example, morpholine octanoate. In other embodiments, the hydrotrope may be a cationic protonated amine oxide, such as, for example, dimethyl octyl amine oxide, that has been protonated with an acid.

For hydrotropes having single and cyclic tails, the total number of carbon atoms in the tail may be between 7 and 11. It is believed that a tail comprising 7-11 carbon atoms produces sufficient lipophilic nature to allow the tails to associate into liquid crystal bi-layers. For hydrotropes having dual or twin polar head groups, the number of carbon atoms may be 7-11 carbon atoms per polar head group. Examples of hydrotropes that can be used in the present invention are triethanolamine octanoate, morpholine octanoate, sodium octyl sulphate, sodium cumene sulphonate, sodium xylene sulphonate, sodium toluene sulphonate and sulphonated oleic acid.

Experiments indicate that for linear tails, a minimum chain length of around 7-8 carbon atoms is preferred in order to form liquid crystals. Amphiphiles with a chain length shorter than this may be too soluble. The preferred short chain lengths of the lipophilic tails of the amphiphiles, i.e. around 7 to 10 carbon atoms, are believed to form narrow bi-layers that are extremely flexible, and this flexibility allows them to pack into micro-vesicles that contain only a small number (e.g. 5) of concentric shells. It is believed that these micro-vesicles are nano droplets of lamellar phase that have a positively charged surface, although they are overall electrically neutral. Without being bound by theory, it is believed that the unequal charge distribution across the droplets causes the droplets to constantly repel each other, resulting in a 3 D structure having a yield point that can suspend solids, liquids, or gases.

Linear amphiphiles with longer chains, i.e. 12 carbon atoms and above, may give thicker bi-layers which are more rigid and tend to pack into multilamellar macro vesicles with several dozen concentric shells. The macrovesicles are of a size that they reflect rather than transmit light with the consequence that these particular systems are opaque. However, it may be possible to include amphiphiles having linear tails with 12 carbon atoms or more, provided that at least a majority of the lipophilic tails in the overall blend of low HLB and high HLB amphiphiles have less than 12 carbon atoms.

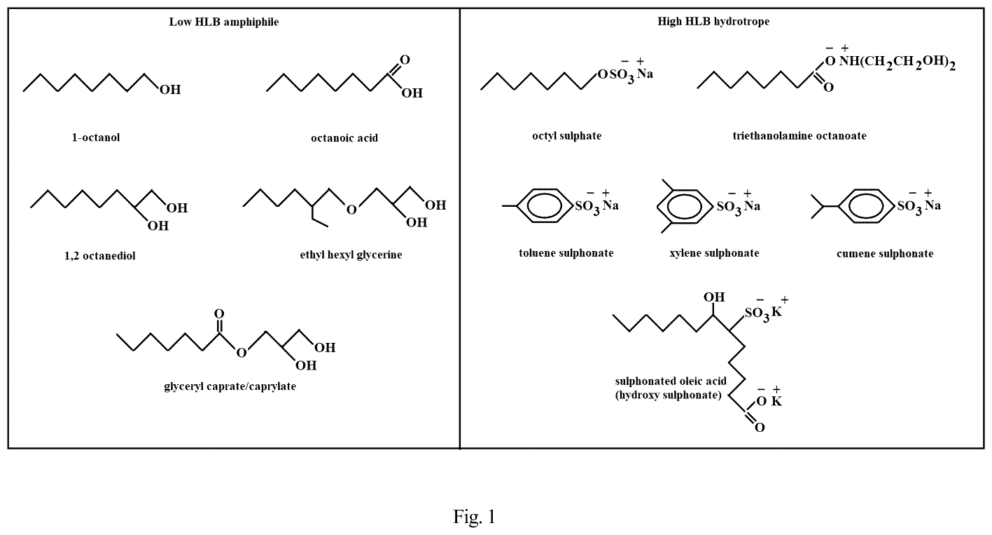

FIG. 1 provides examples of low and high HLB amphiphiles of the invention that have been found to be effective. Any combination of the low HLB amphiphiles in FIG. 1 may be blended together with any combination of the high HLB amphiphiles (hydrotropes) in FIG. 1 to produce a structured aqueous system with a high degree of clarity that are capable of suspending solids. However, the examples in FIG. 1 are not intended to be an exhaustive listing of examples of the invention.

The at least one water soluble amphiphile (hydrotrope) and the at least one water insoluble amphiphile are mixed together in water to give the structured aqueous system. The active components of the suspending system (i.e. the hydrotrope and the at least one water insoluble amphiphile) may be present in a total amount of about 2 to about 50% w/w, about 4 to about 45% w/w, about 6 to about 40% w/w, about 8 to about 35% w/w, about 10 to about 30% w/w, or about 15 to about 25% w/w, based on the total weight of the structured aqueous system.

The hydrotrope and the at least one water insoluble amphiphile may be present in a total amount of at least about 2% w/w, about 4% w/w, about 6% w/w, about 8% w/w, about 10% w/w, about 12% w/w, about 14% w/w, about 16% w/w, about 18% w/w, about 20% w/w, about 22% w/w, about 24% w/w, about 26% w/w, about 28% w/w, about 30% w/w, about 35% w/w, about 40% w/w, about 45% w/w, or at least about 50% w/w, based on total weight of the structured aqueous system.

The hydrotrope and the at least one water insoluble amphiphile may be present in a total amount of no more than about 2% w/w, about 4% w/w, about 6% w/w, about 8% w/w, about 10% w/w, about 12% w/w, about 14% w/w, about 16% w/w, about 18% w/w, about 20% w/w, about 22% w/w, about 24% w/w, about 26% w/w, about 28% w/w, about 30% w/w, about 35% w/w, about 40% w/w, about 45% w/w, or about 50% w/w, based on the total weight of the structured aqueous system.

In some embodiments, the concentration of the amphiphiles may need to be 10% by weight or more in order “pack” the available volume and provide a yield point. However, adding a component to the structured aqueous system that can increase the repulsion of the nano droplets may be able to provide a yield point at an actives concentration of less than 10%. Components that may be able to increase the repulsion between nano droplets include morpholine soaps, C8/C10 alkyl amine oxides, 1,4-thiazine, thiomorpholine, and thiomorpholine 1,1 dioxide.

The ratio of hydrotrope to water insoluble amphiphile is determined at least in part, by the particular hydrotrope and water insoluble amphiphile forming the structured system. Suitable suspending systems comprising the high and low HLB amphiphiles, and the optimum ratio of the particular constituents, can be determined by experiment. Various ratios of the hydrotrope and water insoluble amphiphile are preblended together, then diluted with water to a total active concentration of about 15% by weight and mixed (manual low shear mixing). Those compositions that thicken on mixing and remain substantially transparent then have air shaken into them. Isotropic (to visible light) compositions that suspend air bubbles are identified, and then assessed as ‘strong’ or ‘weak’ (high or low yield point) depending on whether the systems suspend large or small air bubbles. Over a range of samples prepared with differing ratios of high to low HLB amphiphiles, it is usual for several samples to show suspending properties. The mid-range samples of a range tend to exhibit the highest yield points, i.e. suspend the largest bubbles, the centre of the mid-range is therefore identified as the optimum ratio for micro vesicle formation. In general, suitable weight ratios of water insoluble amphiphile to hydrotrope may be in the range of 1:1 to about 4:1.

The structured aqueous system is prepared by low-shear mixing of each of the constituent components together at room temperature, or temperature above room temperature, for example about 27, about 28, about 29, about 30, about 32, about 34, or about 35° C. Mixing is applied until the blend thickens and attains a yield point, which is when the blend becomes capable of suspending insoluble (solid, liquid or gas) particles. The amphiphiles are usually (but not essentially) pre-blended together before dispersing in the water. This has the advantage of preventing any unwanted emulsification taking place. Pre-blending the amphiphiles also has the additional benefit of preparing marketable concentrates for sale to customers who prefer to manufacture the finished structured liquid formulation ‘in house’. The high active concentrates have been found to be pourable and to disperse readily in water with low shear mixing at room temperature to form the structured aqueous systems. The resulting structured aqueous systems are flowable, and achieve good suspending ability without the addition of electrolytes, i.e. they can be electrolyte-free. In some embodiments, the structured aqueous systems are transparent or slightly hazy.

The structured aqueous system may be stable at temperatures ranging from 0 to 60° C., with some systems being stable even at lower or higher temperatures. The structured aqueous systems are low-foaming systems that can be used to suspend a variety of solid, liquid, or gas particles, and are particularly useful for applications where foaming is not desired, or where surfactant systems cannot be used due to interactions with the dispersant material. Particulate solids that can be suspended in the present structured aqueous systems include, but are not limited to, graphene, diamond powder, pesticides and herbicides, and pigments. The total amount of particulate solids that can be suspended in the structured aqueous system can range from about 0.5% to about 60% by weight of the structured aqueous system. The structured aqueous systems may be used in many different applications, such as the preparation of graphene dispersions, diamond suspensions (lapping fluids), oil-free lubricants, cutting fluids, agricultural compositions such as pesticide, herbicide, and/or fertilizer suspensions, pigment suspensions, suspensions of adhesives, media for 3D printing, and ink suspensions.

In some embodiments, the structured aqueous system can be used to suspend graphene particles. One aspect of the present technology is therefore a method for preparing a stable graphene dispersion. The graphene dispersion can be prepared by forming a structured aqueous system comprising water and from 2% to 50% by weight based on the weight of the structured aqueous system of a mixture of at least one water soluble amphiphile and at least one hydroxyl-terminated water insoluble amphiphile, wherein the at least one water soluble amphiphile is a hydrotrope comprising at least one polar head group and a lipophilic tail group with from 6 to 11 carbon atoms per polar head group; and suspending the graphene particles in the structured aqueous system to form the stable graphene dispersion. In some embodiments, the graphene particles can be mixed with the hydrotrope and water to form a homogenous mixture, and then adding the low HLB amphiphile to the mixture to form the structured aqueous system with the graphene particles stably dispersed within the structured aqueous system. Alternatively, the low HLB amphiphile and the hydrotrope can be mixed together to form the structured aqueous system, and the graphene particles can be mixed with the structured aqueous system to form the stable graphene dispersion. In some embodiments, the low HLB amphiphile and the hydrotrope can be pre-blended to form a concentrate, which is then diluted to form the structured aqueous system. The graphene particles could be mixed with the concentrate prior to dilution.

### EXAMPLES

The following examples describe some of the preferred embodiments of the present technology without limiting the technology thereto. Other embodiments include, but are not limited to, those described in the above written description, including additional or alternative components, alternative concentrations, and additional or alternative properties and uses.

### Example 1

The optimum ratio of High to Low HLB amphiphile was determined for several binary blends by the method described in paragraph above. All the blends had a strong yield point i.e. they suspended large air bubbles at room temperature without degassing. The blends are listed in Table 1 below.

TABLE 1

| Sample | | | | % Total | |
|---|---|---|---|---|---|
| Identifi- | High HLB | Low HLB | Ratio | Active in | |
| cation | Hydrotrope | Amphiphile | A:B | water | |
| Code | [A] | [B] | w/w | w/w | Appearance |
| 1 | Sodium cumene | Octanol | 1:1 | 20 | clear |
| | sulphonate | | | | |
| 2 | Sodium octyl | Octanoic | 1:2 | 15 | slight haze |
| | sulphate | acid | | | |
| 3 | Sodium cumene | Glyceryl | 1:2.5 | 20 | slight haze |
| | sulphonate | caprylate/ | | | |
| | | caprate | | | |
| 4 | Triethanolamine | Octanoic | 1:1.25 | 20 | clear |
| | salt of | acid | | | |
| | Octanoic acid | | | | |
| 5 | Sulphonated | Glyceryl | 1:3 | 15 | clear |
| | oleic acid | caprylate/ | | | |
| | | caprate | | | |
| 6 | Sodium cumene | 1,2 Octane | 1:3.5 | 15 | slight haze |
| | sulphonate | diol | | | |
| 7 | Phosphoric acid | Glyceryl | 1:3 | 15 | hazy |
| | di-(C4-C18)- | caprylate/ | | | |
| | alkyl esters | caprate | | | |
| | ammonium salts | | | | |
| 8 | Sodium octyl | Glyceryl | 1:4 | 15 | slight haze |
| | sulphate | caprylate/ | | | |
| | | caprate | | | |
| 9 | Sodium octyl | 1,2 Octane | 1:4 | 15 | clear |
| | sulphate | diol | | | |

The structure of samples 1, 3, 4, 6, 8, and 9 listed in Table 1 was analysed by small angle x-ray scattering. The scattering patterns of the samples all exhibited weak scattering giving a symmetric hump with a peak around 30 to 40 Angstroms. On the further evidence of electron micrographs, it is believed that these systems comprise regularly sized micro-vesicles having around 3-6 concentric shells.

### Example 2

The optimum ratio of High to Low HLB amphiphile was determined for sodium xylene, toluene, and cumene sulphonates in combination with glyceryl caprylate/caprate by the method described in paragraph above. For this series, the total active concentration was fixed at 25% w/w. The ratios are shown in Table 2.

TABLE 2

| | | Moles of glyceryl |
|---|---|---|
| | w/w ratio Hydrotrope: | caprylate/caprate |
| | Glyceryl caprate/caprylate | per mole of |
| Hydrotrope | at maximum yield point | Hydrotrope |
| Sodium Toluene | 1:1 | 2 |
| Sulphonate | Weakest yield point | |
| Sodium Xylene | 1:1.75 | 1 |
| Sulphonate | Intermediate yield point | |
| Sodium Cumene | 1:2.5 | 1.5 |
| Sulphonate | Strongest yield point | |

The strongest suspending system was obtained with sodium cumene sulphonate and the weakest with sodium toluene sulphonate. Sodium xylene sulphonate was intermediate between the two. These results show that the yield point of the system increases with increasing amounts of alkyl substituents on the benzene ring, and that the micro vesicles comprise around 3 molecules of low HLB amphiphile per 2 molecules of hydrotrope.

### Example 3

Various ratios of glyceryl oleate and sodium cumene sulphonate were examined at 15% total actives by the method described in paragraph above. An opaque structured system was obtained at 2:1 w/w oleate:sulphonate. This gives confirmation that high quantities of longer linear tails (>C10) produce large vesicles which scatter light and give opaque suspending systems.

### Example 4

Sodium cyclamate (sweetener and hydrotrope) could not be induced to form a structured system when combined with either Lactem or oleic acid (low HLB emulsifiers). This gives good confirmation that at least one pendant methyl group should be present in order for a hydrotrope containing a C6 ring to function as a co-structurant.

### Example 5

Pure (99%) lauric acid was partially neutralised with triethanolamine in hot (60° C.) water to give 15% w/w blends of lauric acid (low HLB component) plus lauric acid soap (high HLB component). Ratios of 1.5:1, 1:1 and 1.0:1.5 w/w lauric acid: TEA soap were prepared. Pourable cloudy liquids with strong yield points were obtained. However, the samples had a ‘lumpy’ inhomogeneous appearance (like dispersed lumps of gel), unlike the clear isotropic systems obtained with C7-C10 chains. These results indicate that the lipophilic tails should have an alkyl chain length of less than 12 carbon atoms.

### Example 6

A blend of 1:1.4 w/w octanoic acid: morpholine octanoate at a total actives concentration of 10% by weight in water is prepared and forms a structured system with good suspending power. It is thought this may be due to charge repulsion from the lone pair on the oxygen in the morpholine, endowing the lattice with additional energy. This particular system has textures when viewed between polarising filters, indicating that the system is anisotropic.

### Example 7

A 0.5% w/w graphene dispersion was prepared using a structured aqueous system in which the low HLB amphiphile was octanoic acid and the hydrotrope was triethanolamine octanoate. The ratio of octanoic acid to triethanolamine octanoate was 1.25 parts by weight octanoic acid to 1.0 parts by weight triethanolamine octanoate, at a total actives concentration of 17.5% by weight based on the total weight of the structured aqueous system. After three weeks of storage at room temperature, the graphene dispersion had no visible sedimentation of the graphene.

### Example 8

The same structured aqueous system as Example 7 was used to prepare a 2% w/w graphene oxide dispersion, except the total actives concentration was 15% by weight rather than 17.5%. The dispersion had a viscosity of about 1000 cps at room temperature, was pourable, and was non-sedimenting for more than three weeks.

### Example 9

A 40 g sample of ‘puregraph 50’ (100% graphene) was mixed with 12 g sulphonated oleic acid (50% solids) and 150 g DI water, and homogenized with a Silverson mixer at room temperature for 45 minutes. The pH of the homogenized mixture was 5.5. Then 7.6 g of glyceryl caprylate/caprate (StepanMild® GCC available from Stepan Company, Northfield, Illinois) was gently stirred into 86.1 g of the mixture by hand with a spatula. The graphene composition comprised 18.2% w/w graphene, 10.8% surfactant actives at a ratio of 3:1 w/w glyceryl caprylate/caprate: sulphonated oleic acid. The composition is homogenous, stable, and readily pourable (ca. 900 cps at room temperature), and no sedimentation/separation is evident after 4 days at room temperature.

### Example 10

Combinations of N,N-dimethyl-N-octylhydroxylamine (ColaLux C-8 from Colonial) and glyceryl caprylate/caprate (StepanMild® GCC) were prepared at different ratios (15% w/w total actives). The samples spanned the range of 3:1 to 10:1 w/w GCC:Amine oxide and were prepared by hand mixing at room temperature. Only with the sample at 4:1 w/w GCC: Amine oxide did it appear that a very weak structure might be present. However, when a small amount of HCL was added to 4:1 w/w GCC: Amine oxide at 15% actives, a clear, strong structured system was immediately obtained. Without wishing to be bound by theory, it is believed that under acidic conditions, the N—O amino group is protonated to give a cationic hydroxylamine, as shown in the reaction scheme below, and this species appears to promote nano droplet formation.

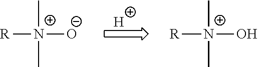

These results show that it may be possible to form a structured system after formation of a solids dispersion. For example, solid particles could be dispersed in a neutral aqueous mix of StepanMild®GCC and amine oxide, any entrained air could be removed, and then the dispersion is acidified with an acid to form the structured system.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

1. A structured aqueous system having a yield point and capable of suspending particles of solid, liquid or gas, the structured aqueous system comprising:
(a) from 2% to 50% by weight based on the weight of the structured aqueous system of a mixture of at least one water soluble amphiphile and at least one water insoluble hydroxy-terminated amphiphile, wherein the at least one water soluble amphiphile is a hydrotrope comprising at least one polar head group and a lipophilic tail group with from 6 to 11 carbon atoms per polar head group, and
(b) water to total 100% of the structured aqueous system.

2. The structured aqueous system of claim 1, wherein the at least one water soluble amphiphile and the at least one water insoluble amphiphile are present in a total amount of between 10% and 30% by weight of the structured aqueous system.

3. The structured aqueous system of claim 1, wherein the water insoluble amphiphile has a hydrophobic tail portion containing from 6 to 11 carbon atoms.

4. The structured aqueous system of claim 1, wherein the hydrotrope is selected from the group consisting of sodium toluene sulphonate, sodium xylene sulphonate, sodium cumene sulphonate, octyl sulphate, triethanolamine octanoate, morpholine octanoate, sulphonated oleic acid, and phosphoric acid di-(C4-C18)-alkyl esters.

5. The structured aqueous system of claim 1, wherein the water insoluble amphiphile comprises at least one additional hydroxyl group.

6. The structured aqueous system of claim 1, wherein the water insoluble amphiphile is selected from the group consisting of 1-octanol, octanoic acid, 1,2 octanediol, ethyl hexyl glycerine, and glyceryl caprate/caprylate.

7. The structured aqueous system of claim 1, wherein the weight ratio of water insoluble amphiphile to hydrotrope is in the range of 1:1 to 4:1.

8. The structured aqueous system of claim 1, wherein the structured aqueous system further comprises solid particles, liquid droplets, or gas bubbles stably suspended within the structured aqueous system.

9. The structured aqueous system of claim 8, wherein the solid particles comprise graphene.

10. The structured aqueous system of claim 8, wherein the solid particles comprise up to 60% by weight of the structured aqueous system.

11. A composition comprising:
(a) a structured aqueous system comprising water and from 2% to 50% by weight based on the weight of the structured aqueous system of a mixture of at least one water soluble amphiphile and at least one hydroxy-terminated water insoluble amphiphile, wherein the at least one water soluble amphiphile is a hydrotrope comprising at least one polar head group and a lipophilic tail group with from 6 to 11 carbon atoms per polar head group; and
(b) from about 0.5% to about 60% by weight based on the weight of the composition of at least one of solid, liquid, or gaseous particles suspended in the structured aqueous system.

12. The composition of claim 11, wherein the at least one water soluble amphiphile and the at least one water insoluble amphiphile are present in a total amount of between 10% and 30% by weight of the structured aqueous system.

13. The composition of claim 11, wherein the water insoluble amphiphile has a hydrophobic tail portion containing between 6 and 11 carbon atoms.

14. The composition of claim 11, wherein the hydrotrope is selected from the group consisting of sodium toluene sulphonate, sodium xylene sulphonate, sodium cumene sulphonate, octyl sulphate, triethanolamine octanoate, morpholine octanoate, sulphonated oleic acid, and phosphoric acid di-(C4-C18)-alkyl esters.

15. The composition of claim 11, wherein the water-insoluble amphiphile comprises at least one additional hydroxyl group.

16. The composition of claim 11, wherein the water insoluble amphiphile is selected from the group consisting of 1-octanol, octanoic acid, 1,2 octanediol, ethyl hexyl glycerine, and glyceryl caprate/caprylate.

17. The composition of claim 11, wherein the solid particles suspended in the structured aqueous system comprise graphene particles.

18. A method of preparing a stable graphene dispersion comprising:
(a) forming a structured aqueous system comprising water and from 2% to 50% by weight based on the weight of the structured aqueous system of a mixture of at least one water soluble amphiphile and at least one hydroxyl-terminated water insoluble amphiphile, wherein the at least one water soluble amphiphile is a hydrotrope comprising at least one polar head group and a lipophilic tail group with from 6 to 11 carbon atoms per polar head group; and
(b) suspending the graphene particles in the structured aqueous system to form the stable graphene dispersion.

19. The method of claim 18, wherein the graphene dispersion comprises up to 60% by weight of graphene particles.

20. The method of claim 18, wherein the graphene particles are mixed with the hydrotrope and water to form a homogenous mixture, and the water insoluble amphiphile is added to the mixture to form the structured aqueous system.

21. The method of claim 18, wherein the water insoluble amphiphile and the hydrotrope are pre-blended to form a concentrate, and the concentrate is diluted with water to form the structured aqueous system.

22. The method of claim 18, wherein the graphene particles suspended in the graphene dispersion are non-sedimenting for at least 3 weeks at room temperature.
